(19) United States
(12) Patent Application Publication
(10) Pub. No.: US 2016/0034621 A1
(43) Pub. Date: Feb. 4, 2016

(54) Numerical Simulation Of Crack Propagation Due To Metal Fatigue

(71) Applicant: Livermore Software Technology Corporation, Livermore, CA (US)

(72) Inventor: Yun Huang, Dublin, CA (US)

(21) Appl. No.: 14/450,643

(22) Filed: Aug. 4, 2014

(51) Int. Cl. G06F 17/50

(52) U.S. Cl. CPC G06F 17/5018

(57) ABSTRACT

FEA model representing a metal object subjected to expected random vibration loadings during a predefined time period is received. Structural dynamic characteristics and responses of the FEA model are obtained. Cumulative damage ratios of all finite elements are computed using the obtained structural dynamic responses along with a S-N curve for the metal object, and predefined time period. Time and location of fatigue failure in the FEA model are determined by identifying which one of the finite elements fails first. The identified failed finite element's cumulative damage ratio reaches unity first. The FEA model is revised by removing the identified failed finite element. Then the revised FEA model is used for repeating the process of identifying another fatigue failure until the determined time of fatigue failure has passed the predefined time period. All identified failed finite elements represent simulated fatigue crack propagation.

### FIELD

The present invention generally relates to computer-aided engineering analysis of a product (e.g., car, airplane, etc.), more particularly to systems and methods of numerically simulating crack propagation due to metal fatigue.

### BACKGROUND

Computer aided engineering (CAE) has been used for supporting engineers in many tasks. For example, in a structure or product design procedure, CAE analysis, in particular finite element analysis (FEA), has often been employed to evaluate responses (e.g., stresses, displacements, etc.) under various loading conditions (e.g., static or dynamic). And the loadings can be nondeterministic (e.g., random vibration).

FEA is a computerized method widely used in industry to simulate (i.e., model and solve) engineering problems relating to complex products or systems (e.g., cars, airplanes, etc.) such as three-dimensional linear and/or non-linear structural design and analysis. FEA derives its name from the manner in which the geometry of the object under consideration is specified. The geometry is defined by elements and nodes. There are many types of elements, solid elements for volumes or continua, shell or plate elements for surfaces and beam or truss elements for one-dimensional structure objects.

In material science, fatigue is defined as the weakening of material caused by repeatedly applied loads. Progressive and localized structural damage occurs due to repetitive loading-and-unloading cycles. The stress level due to the repeatedly applied loads is usually lower than the metal's strength (e.g., tensile stress limit or yield stress limit). Due to accumulated damage, the material may still fail after sufficient number of loading-and-unloading cycles. One of the challenging tasks of FEA is to numerically predict fatigue crack propagation in a metal object subjected to such cyclical loadings. Prior art approaches generally require time-domain based techniques (e.g., nonlinear time domain analysis). Drawbacks of prior art approaches include difficult to practice due to nonlinearity, intensive computational costs, and/or singularity as a result of a crack in the FEA model. Therefore, it would be desirable to have improved methods and systems for obtaining numerically simulated fatigue crack propagation in a metal object subjected to expected random vibration loadings during a predefined time period.

### SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Methods and systems for obtaining numerically simulated fatigue crack propagation in a metal object (e.g., component, part, product, etc.) subjected to expected random vibration loadings during a predefined time period (e.g., design service life of the metal object) are disclosed. According to one aspect, a finite element analysis (FEA) model representing a metal object is received in a computer system having one or more application modules installed thereon. Expected random vibration loadings during the predefined time period (e.g., in form of power spectral density (PSD) function in frequency domain) is also received.

Structural dynamic characteristics and responses of the FEA model are obtained. Cumulative damage ratios of all finite elements in the FEA model are computed by using the obtained structural dynamic responses along with a Stress-versus-‘Number-of-cycles-to-failure’ (S-N) curve for the metal object.

Time and location of fatigue failure in the FEA model are determined by identifying which one of the finite elements fails first. The finite element whose cumulative damage ratio reaches unity (i.e. one (1)) fails first. The FEA model is then revised by removing the identified failed finite element. Then the revised FEA model is used for repeating the process of identifying another failed finite element due to fatigue until the determined time of fatigue failure has passed the predefined time period. All of the identified failed finite elements represent the numerically simulated fatigue crack propagation in the metal object.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a flowchart illustrating an example process of obtaining a numerically simulated fatigue crack propagation in a metal object subjected to expected random vibration loadings during a predefined time period, according to one embodiment of the present invention;

FIG. 2 is a diagram showing a numerically simulated fatigue crack propagation in an example FEA model, according to one embodiment of the present invention;

FIG. 3 is a diagram showing an example acceleration PSD function representing expected random vibration loadings, according to an embodiment of the present invention;

FIG. 4 is a diagram illustrating an example stress PSD function according to one embodiment of the present invention;

FIG. 5 is a diagram showing an example S-N curve, according to one embodiment of the present invention; and

FIG. 6 is a function block diagram showing salient components of an example computer system, in which one embodiment of the present invention may be implemented.

### DETAILED DESCRIPTIONS

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

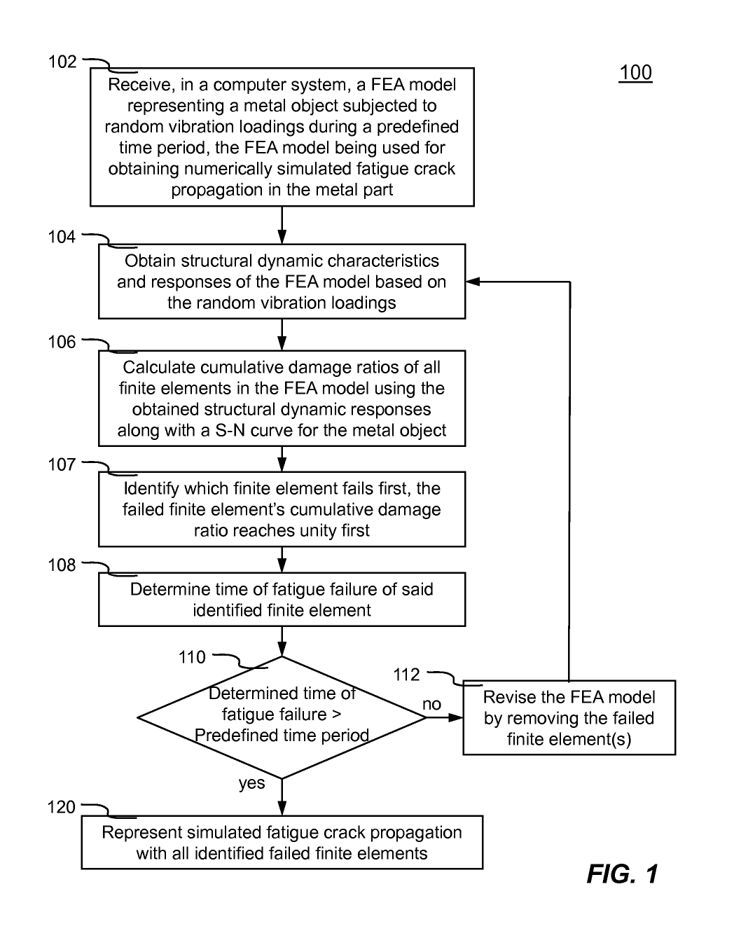

Embodiments of the present invention are discussed herein with reference to FIGS. 1-6. However, those skilled in the art will readily appreciate that the detailed description given herein with respect to these figures is for explanatory purposes as the invention extends beyond these limited embodiments.

Referring first to FIG. 1, it shows a flowchart illustrating an example process 100 of obtaining numerically-simulated fatigue crack propagation in a metal object subjected to expected random vibration loadings during a predefined time period. Process 100 is implemented in software and understood with other figures.

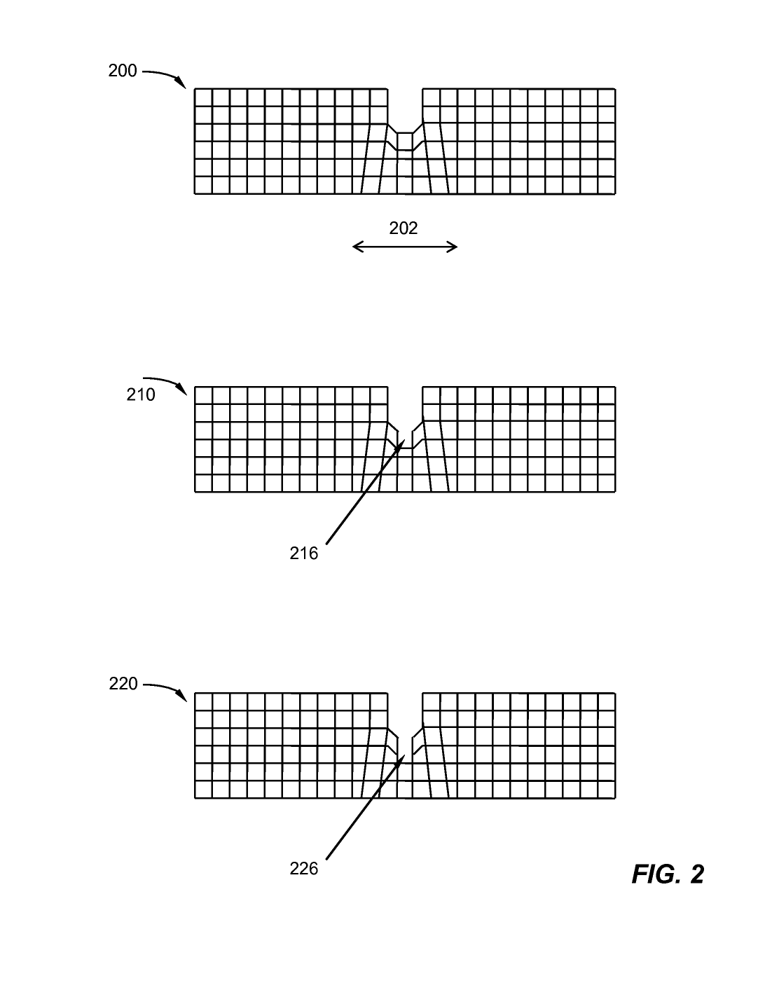

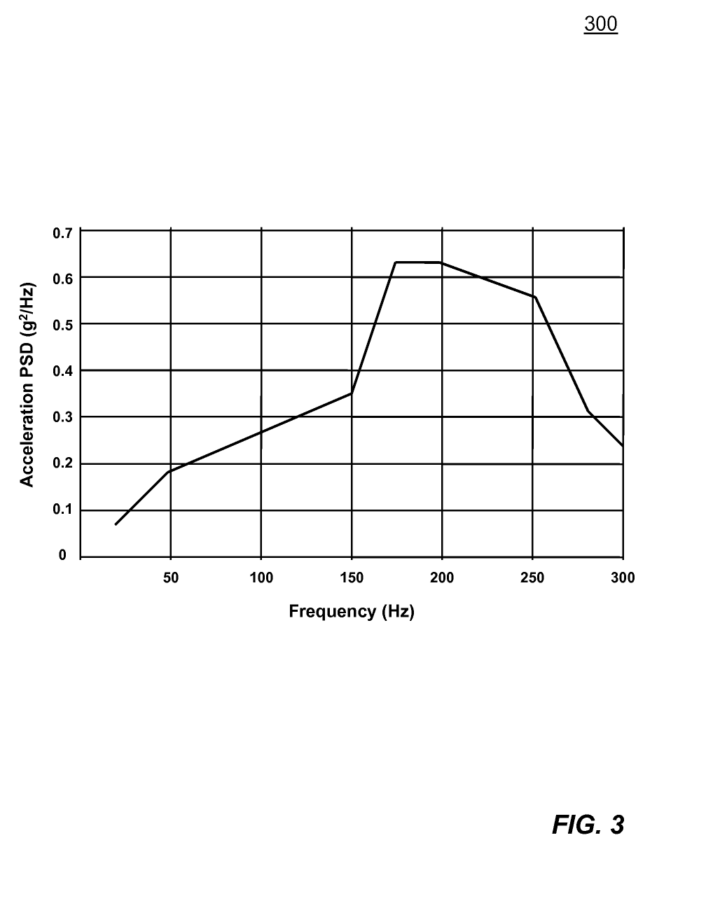

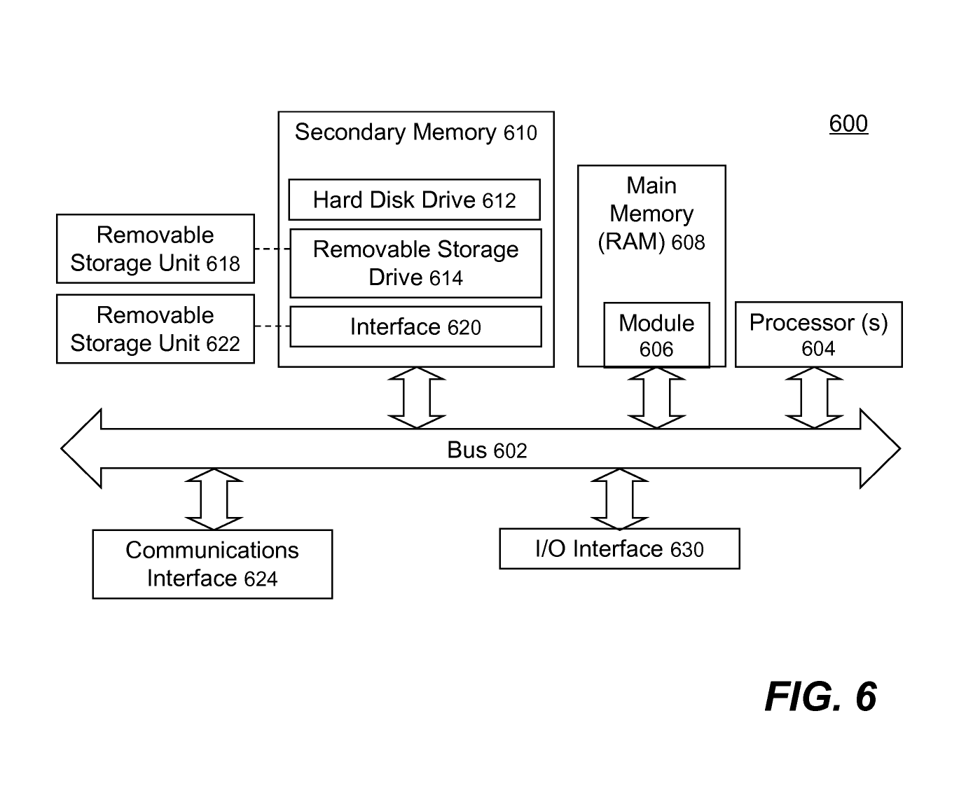

Process 100 starts, at action 102, by receiving a finite element analysis (FEA) model representing a metal object (e.g., component, part, product, etc.) in a computer system (e.g., computer 600 of FIG. 6) having one or more application modules installed thereon. Metal object is made at least in-part of metal (e.g., steel, aluminum, metal alloy, etc.) and subjected to expected random vibration loadings during a predefined time period (e.g., design service life span). Expected random vibration loadings in the duration of predefined time period may be defined as a power spectral density (PSD) function in frequency domain by user. FEA model is used for obtaining numerically simulated fatigue crack propagation by said one or more application modules. FIG. 2 shows an example FEA model 200 under cyclical loadings 202 (shown as an arrow, e.g., sinusoidal loads). In one embodiment, expected random vibration loadings are a nondeterministic combination of cyclical loadings, which may be represented as an example PSD function 300 in FIG. 3. PSD function 300 can be mathematically generated by performing Fourier transform of an autocorrelation function of a signal (e.g., a series of random loads). The example PSD function 300 (sometimes referred to as acceleration spectral density function) shown in FIG. 3 is for acceleration density (i.e., g²/Hz) in a range of frequencies (Hz). Accelerations may represent prescribed or enforced motions applied to the metal object as random vibration loadings.

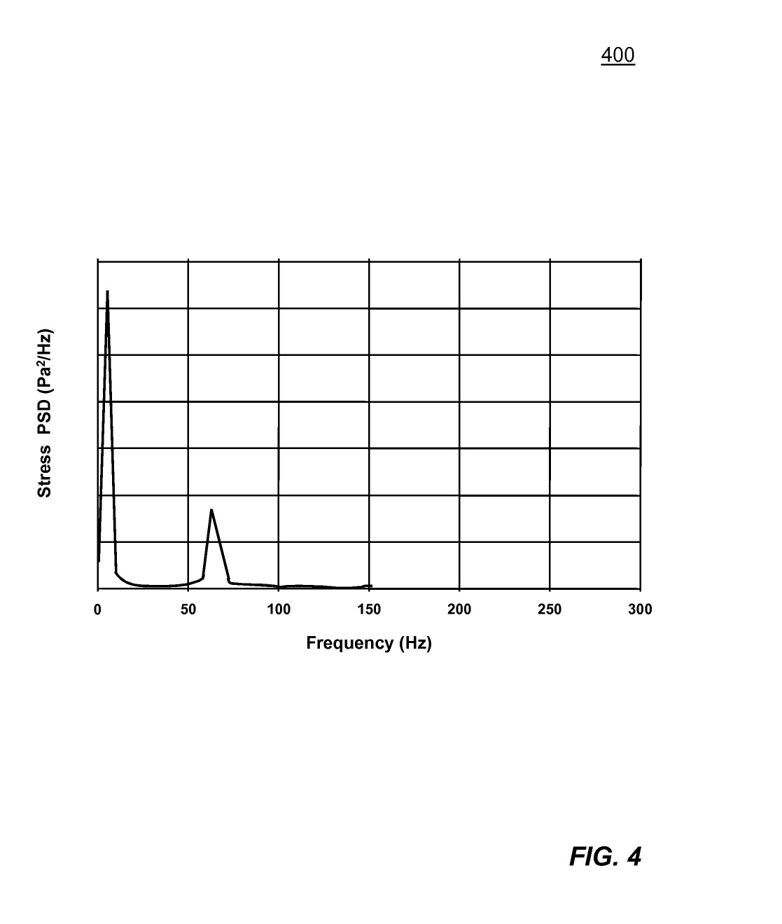

Next, at action 104, structural dynamic characteristics of the FEA model are obtained using one of the application modules (e.g., FEA software). Structural dynamic characteristics include, but are not necessarily limited to natural frequencies and associated mode shapes of the metal object. Based on the natural frequencies and associated modal shapes, dynamic responses (e.g., stress, displacement, velocity, acceleration, etc.) of the metal object can be obtained via one of several well-known procedures with the expected random vibration loadings as input. Dynamic responses are also represented by PSD and RMS (root mean square that shows standard deviation of a random signal) functions. FIG. 4 shows an example stress PSD function 400 (i.e., dynamic responses) in frequency domain.

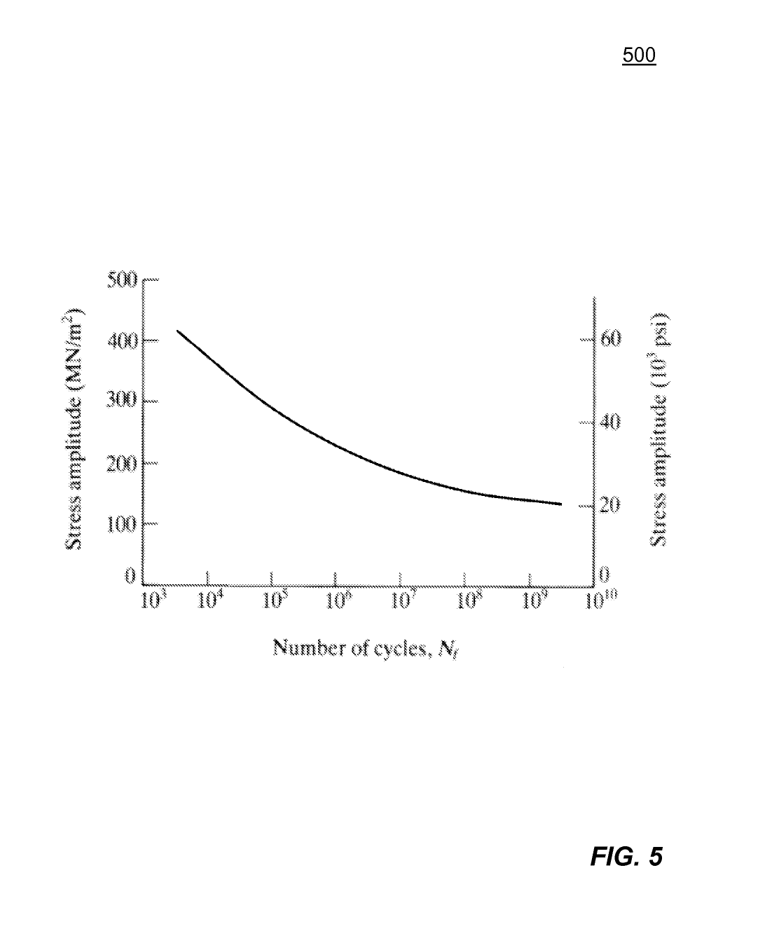

Then, at action 106, cumulative damage ratios of all finite elements of the FEA model are computed using the obtained structural dynamic response, along with a Stress-versus-Number of cycles' (S-N) curve for the metal object, and the predefined time period. FIG. 5 shows an example S-N curve 500. Cumulative damage ratios are computed based on Palmgren-Minor's rule:

$$D = {\sum }_{i} \frac{{n}_{i}}{{N}_{i}}$$

where:
D is cumulative damage ratio,
nᵢ is the actual number of cycles at stress level Sᵢ, and
Nᵢ is the number of cycles to failure at stress level Sᵢ, given by the materials'S-N curve.

A number of well-known approaches can be used for computing the cumulative damage ratio. Any one of them may be used in accordance with an embodiment of the present invention.

At action 107, process 100 identifies which one of the finite elements in the FEA model fails first. This can be accomplished by examining the computed cumulative damage ratios. The failed finite element is the one with its cumulative damage ratio reaches unity (i.e., one (1)) first. Although unlikely, it is possible there are multiple finite elements having their respective cumulative damage ratios reach unity simultaneously.

Then, at action 108, fatigue failure time associated with the identified failed finite element or elements is determined. In one embodiment, the fatigue failure time is determined by monitoring the computed cumulative damage ratios. Whichever finite element having its cumulative damage ratio reaches unity is used for determining the fatigue failure time.

In an alternative embodiment, cumulative damage ratios are computed for the entire predefined time period. Then the finite element having highest cumulative damage ratio is the one fails first. The failure time of the first failure may be determined by a linear interpolation technique. For example, the computed cumulative damage ratio of a particular finite element is ten (10) for a predefined time period. The first fatigue failure occurs at one tenths of the predefined time period. Using this technique (i.e., linear interpolation) requires that the next iteration starts at the previously determined fatigue failure time. For example, the previously determined fatigue failure time is at one tenths ( 1/10) of the predefined time period (T).

Next, at decision 110, it is determined whether the determined time of fatigue failure has passed the predefined time period. If not, process 100 follows the “no” path to action 112 to revise/modify the FEA model by removing the failed finite element or elements. Process 100 then loops back to action 104 to repeat actions/decisions 104-110 until decision 110 becomes true. When process 100 loops back to action 104, remaining finite elements in the revised FEA model start with cumulative damage ratios computed from actions 107 and 108 of previous iteration. Process 100 ends by representing the simulated fatigue crack propagation with all of the identified failed finite elements at action 120. Example showing respective revised FEA models 210-220 in consecutive iterations is shown in FIG. 2. In each of the revised FEA models 210-220, respective failed finite elements 216-226 represent a crack due to fatigue failure.

An example is described herein to further demonstrate the alternative embodiment for determining the fatigue failure time in each consecutive iteration of process 100. After the initial failure time being determined at one fifth (0.1T) of the predefined time period (T), in next iteration, the cumulative damage ratios are computed for the remaining of the predefined time period (i.e., from 0.1T to T) for the revised FEA model. And respective cumulative damage ratios of the remaining finite elements in the revised FEA model start at a value corresponding to the previously determined fatigue failure time (0.1T). For example, one of the remaining finite elements has computed cumulative damage ratio of nine (9) in the previous iteration. At the determined fatigue failure time (0.1 T), the cumulative damage ratio of this finite element would be scaled back to 0.9 before the beginning of the next iteration (i.e., actions/decision 104-110).

According to another aspect, the present invention is directed towards one or more computer systems capable of carrying out the functionality described herein. An example of a computer system 600 is shown in FIG. 6. The computer system 600 includes one or more processors, such as processor 622. The processor 622 is connected to a computer system internal communication bus 620. Various software embodiments are described in terms of this exemplary computer system. After reading this description, it will become apparent to a person skilled in the relevant art(s) how to implement the invention using other computer systems and/or computer architectures.

Computer system 600 also includes a main memory 608, preferably random access memory (RAM), and may also include a secondary memory 610. The secondary memory 610 may include, for example, one or more hard disk drives 612 and/or one or more removable storage drives 614, representing a floppy disk drive, a magnetic tape drive, an optical disk drive, etc. The removable storage drive 614 reads from and/or writes to a removable storage unit 618 in a well-known manner. Removable storage unit 618, represents a flash memory, floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as Erasable Programmable Read-Only Memory (EPROM), Universal Serial Bus (USB) flash memory, or PROM) and associated socket, and other removable storage units 622 and interfaces 620 which allow software and data to be transferred from the removable storage unit 622 to computer system 600. In general, Computer system 600 is controlled and coordinated by operating system (OS) software, which performs tasks such as process scheduling, memory management, networking and I/O services.

There may also be a communications interface 624 connecting to the bus 602. Communications interface 624 allows software and data to be transferred between computer system 600 and external devices. Examples of communications interface 624 may include a modem, a network interface (such as an Ethernet card), a communications port, a PCMCIA slot and card, etc.

The computer 600 communicates with other computing devices over a data network based on a special set of rules (i.e., a protocol) to send data back and forth. One of the common protocols is TCP/IP (Transmission Control Protocol/Internet Protocol) commonly used in the Internet. In general, the communication interface 624 manages the assembling of a data file into smaller packets that are transmitted over the data network or reassembles received packets into the original data file. In addition, the communication interface 624 handles the address part of each packet so that it gets to the right destination or intercepts packets destined for the computer 600.

In this document, the terms “computer recordable storage medium”, “computer recordable medium” and “computer readable medium” are used to generally refer to media such as removable storage drive 614, and/or a hard disk installed in hard disk drive 612. These computer program products are means for providing software to computer system 600. The invention is directed to such computer program products.

The computer system 600 may also include an I/O interface 630, which provides the computer system 600 to access monitor, keyboard, mouse, printer, scanner, plotter, and alike.

Computer programs (also called computer control logic) are stored as application modules 606 in main memory 608 and/or secondary memory 610. Computer programs may also be received via communications interface 624. Such computer programs, when executed, enable the computer system 600 to perform the features of the present invention as discussed herein. In particular, the computer programs, when executed, enable the processor 604 to perform features of the present invention. Accordingly, such computer programs represent controllers of the computer system 600.

In an embodiment where the invention is implemented using software, the software may be stored in a computer program product and loaded into computer system 600 using removable storage drives 614, hard drive 612, or communications interface 624. The application module 606, when executed by the processor 604, causes the processor 604 to perform the functions of the invention as described herein.

The main memory 608 may be loaded with one or more application modules 606 that can be executed by one or more processors 604 with or without a user input through the I/O interface 630 to achieve desired tasks. In operation, when at least one processor 604 executes one of the application modules 606, the results (e.g., cumulative damage ratios for each iteration) are computed and stored in the secondary memory 610 (i.e., hard disk drive 612). For example, the obtained structural dynamic characteristics can be saved to memory and reported to the user via the I/O interface 630 either as a list or a graph.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas a two-dimensional example FEA model have been shown and described, other types of FEA model may be used to achieve the same, for example, a three-dimensional FEA model with different number of finite elements contained therein. In summary, the scope of the invention should not be restricted to the specific exemplary embodiments disclosed herein, and all modifications that are readily suggested to those of ordinary skill in the art should be included within the spirit and purview of this application and scope of the appended claims.

I claim:

1. A method of obtaining numerically simulated fatigue crack propagation in a metal object subjected to expected random vibration loadings during a predefined time period comprising:
(a) receiving, in a computer system having one or more application modules installed thereon, a finite element analysis (FEA) model representing the metal object and expected random vibration loadings during a predefined time period, the FEA model containing a plurality of nodes connected by a plurality of finite elements;
(b) obtaining, by said one or more application modules, structural dynamic responses of the FEA model based on the expected random vibration loadings;
(c) calculating, by said one or more application modules, respective cumulative damage ratios of all of the finite elements in the FEA model using the obtained structural dynamic responses along with a Stress-versus-‘Number-of-cycles-to-failure’ (S-N) curve for the metal object;
(d) identifying, by said one or more application modules, which finite element fails first, wherein the failed finite element's cumulative damage ratio reaches unity first;
(e) determining, by said one or more application modules, a fatigue failure time of said identified failed finite element;
(f) revising, by said one or more application modules, the FEA model by removing said identified failed finite element; and
(g) repeating (b)-(f), by said one or more application modules, using the revised FEA model until said determined fatigue failure time has passed the predefined time period, wherein the numerically simulated fatigue crack propagation is represented by all of the identified failed finite elements.

2. The method of claim 1, wherein the expected random vibration loadings are represented by a power spectrum density function in frequency domain.

3. The method of claim 1, wherein the predefined time period comprises the metal object's design service life.

4. The method of claim 1, said obtaining the structural dynamic responses further comprises extracting natural vibration frequencies and associated mode shapes of the FEA model by conducting an eigensolution.

5. The method of claim 4, wherein the structural dynamic responses comprise respective power spectral density functions of said structural dynamic responses of the FEA model in response to the expected random vibration loadings with the extracted natural frequencies and the associated mode shapes.

6. The method of claim 1, wherein each of said cumulative damage ratios is calculated based on Palmgren-Minor's rule.

7. A system for obtaining numerically simulated fatigue crack propagation in a metal object subjected to expected random vibration loadings during a predefined time period comprising:
an input/output (I/O) interface;
a memory for storing computer readable code for one or more application modules;
at least one processor coupled to the memory, said at least one processor executing the computer readable code in the memory to cause said one or more application modules to perform operations of:
(a) receiving a finite element analysis (FEA) model representing the metal object and expected random vibration loadings during a predefined time period, the FEA model containing a plurality of nodes connected by a plurality of finite elements;
(b) obtaining, by said one or more application modules, structural dynamic responses of the FEA model based on the expected random vibration loadings;
(c) calculating, by said one or more application modules, respective cumulative damage ratios of all of the finite elements in the FEA model using the obtained structural dynamic responses along with a Stress-versus-‘Number-of-cycles-to-failure’ (S-N) curve for the metal object;
(d) identifying, by said one or more application modules, which finite element fails first, wherein the failed finite element's cumulative damage ratio reaches unity first;
(e) determining, by said one or more application modules, a fatigue failure time of said identified failed finite element;
(f) revising, by said one or more application modules, the FEA model by removing said identified failed finite element; and
(g) repeating (b)-(f), by said one or more application modules, using the revised FEA model until said determined fatigue failure time has passed the predefined time period, wherein the numerically simulated fatigue crack propagation is represented by all of the identified failed finite elements.

8. The system of claim 7, wherein the expected random vibration loadings are represented by a power spectrum density function in frequency domain.

9. The method of claim 7, wherein the predefined time period comprises the metal object's design service life.

10. The system of claim 7, said obtaining the structural dynamic responses further comprises extracting natural vibration frequencies and associated mode shapes of the FEA model by conducting an eigensolution.

11. The system of claim 10, wherein the structural dynamic responses comprise respective power spectral density functions of said structural dynamic responses of the FEA model in response to the expected random vibration loadings with the extracted natural frequencies and the associated mode shapes.

12. The system of claim 7, wherein each of said cumulative damage ratios is calculated based on Palmgren-Minor's rule.

13. A non-transitory computer readable storage medium containing instructions for obtaining numerically simulated fatigue crack propagation in a metal object subjected to expected random vibration loadings during a predefined time period by a method comprising:
(a) receiving, in a computer system having one or more application modules installed thereon, a finite element analysis (FEA) model representing the metal object and expected random vibration loadings during a predefined time period, the FEA model containing a plurality of nodes connected by a plurality of finite elements;
(b) obtaining, by said one or more application modules, structural dynamic responses of the FEA model based on the expected random vibration loadings;
(c) calculating, by said one or more application modules, respective cumulative damage ratios of all of the finite elements in the FEA model using the obtained structural dynamic responses along with a Stress-versus-‘Number-of-cycles-to-failure’ (S-N) curve for the metal object;
(d) identifying, by said one or more application modules, which finite element fails first, wherein the failed finite element's cumulative damage ratio reaches unity first;
(e) determining, by said one or more application modules, a fatigue failure time of said identified failed finite element;
(f) revising, by said one or more application modules, the FEA model by removing said identified failed finite element; and
(g) repeating (b)-(f), by said one or more application modules, using the revised FEA model until said determined fatigue failure time has passed the predefined time period, wherein the numerically simulated fatigue crack propagation is represented by all of the identified failed finite elements.

14. The non-transitory computer readable storage medium of claim 13, wherein the expected random vibration loadings are represented by a power spectrum density function in frequency domain.

15. The non-transitory computer readable storage medium of claim 13, wherein the predefined time period comprises the metal object's design service life.

16. The non-transitory computer readable storage medium of claim 13, said obtaining the structural dynamic responses further comprises extracting natural vibration frequencies and associated mode shapes of the FEA model by conducting an eigensolution.

17. The non-transitory computer readable storage medium of claim 16, wherein the structural dynamic responses comprise respective power spectral density functions of said structural dynamic responses of the FEA model in response to the expected random vibration loadings with the extracted natural frequencies and the associated mode shapes.

18. The non-transitory computer readable storage medium of claim 13, wherein each of said cumulative damage ratios is calculated based on Palmgren-Minor's rule.
